(19) United States
(12) Patent Application Publication
(10) Pub. No.: US 2025/0200231 A1
(43) Pub. Date: Jun. 19, 2025

(54) SYSTEMS AND METHODS FOR COMPUTER-AIDED DESIGN (CAD) EXCHANGE

(71) Applicant: nTopology Inc., New York, NY (US)

(72) Inventors: Blake COURTER, Reading, MA (US); George Albert ALLEN, Nakijin (JP)

(21) Appl. No.: 19/070,258

(22) Filed: Mar. 4, 2025

Related U.S. Application Data
(63) Continuation of application No. 17/689,813, filed on Mar. 8, 2022.
(60) Provisional application No. 63/158,252, filed on Mar. 8, 2021.

(51) Int. Cl. G06F 30/10; G06F 111/10

(52) U.S. Cl. CPC G06F 30/10; G06F 2111/10

(57) ABSTRACT

A system for computer aided design (CAD) body interoperability, which allows a CAD design to be exchanged between a source platform or computing system and a target system by determining one or more implicit equations/functions for a CAD body in the source CAD program, expressing this representation of the CAD body as code, and exporting the code to the target system. In some cases, a portion of the code may be GPU code, which may also be provided to a graphics processing unit of the source computing system to allow the CAD body to be displayed by the source computing system.

### CROSS-REFERENCES

The following applications and materials are incorporated herein by reference, in their entireties, for all purposes: U.S. Provisional Patent Application Ser. No. 63/158,252, filed Mar. 8, 2021; and U.S. patent application Ser. No. 17/689,813, filed Mar. 8, 2022.

### FIELD

The present disclosure relates generally to computer aided design (CAD) techniques, and more specifically, but not exclusively, to systems and methods for generating dynamic code representations that enable interoperability of implicit geometry, and that, for example, can be incorporated with other CAD models or processed for manufacturing.

### BACKGROUND

Computer-aided design (CAD) software can allow a user to create, design, modify, analyze, and optimize a number of products including engine parts, consumer device housings, housewares, and other manufacturable items. A CAD design can represent a mechanical design as one or more CAD bodies. Exchanging these bodies between different systems has traditionally challenged CAD, so improvements in exchange are particularly advantageous.

For example, to generate a physical prototype of the item, or to manufacture the item, the corresponding CAD body/bodies can be exchanged with a 3-D printer or computer numerical control (CNC) machine. Similarly, to collaborate on the design of the item with a second user who uses a different CAD program, the corresponding CAD body/bodies can be exchanged with the different CAD program. How CAD bodies are exchanged is an important process for accurate building of parts, particularly for downstream applications along the design to manufacturing process. The goal is to have a compatible CAD file format for downstream use in other programs. However, existing ways of exchanging CAD bodies between CAD programs (and between CAD programs and other targets) are unsatisfactory.

With over dozens of CAD software available and even more CAD file formats, importing and exporting the right format and data is critical when it comes to data integrity and minimizing errors. Unfortunately, due to nuanced differences in geometry representations, transferring the resulting geometry is inherently unreliable. And, due to differences in the semantics of the programs that produce the geometry output, it is not possible to reliably transfer the various steps used to generate a given CAD body, according to conventional approaches.

Typically, a CAD body is exchanged using a form which is referred to as “dumb geometry.” But a CAD body exchanged using the “dumb geometry” format loses its corresponding feature history. With the feature history missing, editing of the CAD body can be difficult, and design intent can be difficult to infer. Other conventional attempts at exchanging CAD bodies in ways other than via the “dumb geometry” format have typically been unsuccessful. Commands/operations in a source CAD program may not have equivalents in a target CAD program. Or commands/operations exist in both the source CAD program and the target CAD program, but the semantics of the two programs differ. By way of example, a source CAD program can have a command/operation of the form “Object Y=Shell(Object X).” Where the target CAD program lacks this command/operation—or possesses it but with differing semantics—there is no clear path to export to the target CAD program a CAD body which utilizes this command/operation.

In view of the foregoing, a need exists for an improved system and method for exchanging CAD bodies, in an effort to overcome the aforementioned obstacles and deficiencies of conventional approaches.

### SUMMARY

According to various embodiments, computerized approaches can be used to exchange a CAD body in a more satisfactory way. In particular, one or more implicit equations/functions can be determined for a CAD body of a source CAD program. The implicit equation(s)/function(s) can subsequently be expressed as code (referred to as a CodeRep herein). By providing the CodeRep to a target (e.g., a different CAD program or a 3D printer), the CAD body can be exported from the source, and imported by the target.

Exchanged in this way, various benefits can accrue compared to existing exchange approaches. For example, compared to exchange approaches that exchange CAD bodies via meshes, voxels, or boundary representations (B-reps), providing a CodeRep results in a smaller amount of data being transferred. As another example, compared to approaches that exchange CAD bodies using meshes or voxels, providing a CodeRep results in increased preciseness as approximation is not involved. As yet another example, compared to approaches that exchange CAD bodies using “dumb geometry,” using a CodeRep for the exchange can allow for increased editability at a target (e.g., a target CAD system), including allowing for replayability and parametric editing with respect to the exchanged CAD body (e.g., allowing for different parameter values to be specified for the CAD body, for instance changing thicknesses or diameters in the CAD body). As an additional example, the fact that code acts as the exchange medium allows for easy consumption/use at the target (e.g., as opposed to using an unwieldly and/or poorly structured data format as the exchange medium). Various aspects will now be discussed in greater detail.

### BRIEF DESCRIPTION OF THE DRAWINGS

FIG. 1 is an exemplary top-level flow diagram illustrating one embodiment of a process for code interoperability using CodeReps;

FIG. 2 is an exemplary screenshot illustrating one embodiment of a graphical user interface for generating the CodeRep of FIG. 1;

FIG. 3 is an exemplary diagram depicting one embodiment of an entity that can result from converting the CodeRep of FIG. 1 to an explicit form;

FIG. 4 is an exemplary diagram comparing an implicit description of a shape versus an explicit description of a shape according to one embodiment of using the process for code interoperability of FIG. 1;

FIG. 5 is an exemplary screenshot illustrating one embodiment of a target system receiving CodeReps using the process for code interoperability of FIG. 1;

FIG. 6 is an exemplary screenshot illustrating one embodiment of an exchanged CodeRep receiving varying inputs using the process for code interoperability of FIG. 1;

FIG. 7 is an exemplary screenshot illustrating one embodiment for making quick changes to a CAD body when CodeReps are used for exchange using the process for code interoperability of FIG. 1;

FIG. 8 provides an exemplary top-level flow diagram and corresponding screenshots illustrating one embodiment of the inputs/parameters and external geometry when CodeReps are used for exchange using the process for code interoperability of FIG. 1;

FIG. 9 is an exemplary top-level flow diagram illustrating one embodiment of CAD body/bodies exchanged using the process for code interoperability of FIG. 1;

FIG. 10 provides an exemplary top-level flow diagram and corresponding screenshots illustrating one embodiment of the use of CodeReps for exchange where a second/target CAD program is capable of directly consuming code definitions using the process for code interoperability of FIG. 1;

FIG. 11 is an exemplary table comparing a general implicit equation feature and custom feature approaches using the process for code interoperability of FIG. 1, according to one embodiment;

FIG. 12 is an exemplary diagram depicting one embodiment of the example benefits of CodeReps using the process for code interoperability of FIG. 1;

FIG. 13 is an exemplary diagram depicting one embodiment of further example benefits of CodeReps using the process for code interoperability of FIG. 1;

FIG. 14 is an exemplary diagram depicting one embodiment of performing parametric editing at a target system using the process for code interoperability of FIG. 1;

FIG. 15 is an exemplary table summarizing one embodiment of the various features and benefits of using the process for code interoperability of FIG. 1;

FIG. 16 provides exemplary screenshots illustrating one embodiment of the operations which are facilitated by the use of CodeReps using the process for code interoperability of FIG. 1;

FIG. 17 provides further exemplary screenshots illustrating one embodiment of additional operations which are facilitated by the use of CodeReps using the process for code interoperability of FIG. 1;

FIG. 18 is an exemplary table illustrating one embodiment of various CodeRep interoperability aspects using the process for code interoperability of FIG. 1;

FIG. 19 an exemplary table illustrating one embodiment of various ecosystem implementation aspects using the process for code interoperability of FIG. 1;

FIG. 20 is a diagram illustrating one embodiment of an exemplary computer system that can be used to implement the process for code interoperability of FIG. 1.

It should be noted that the figures and Appendix are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DESCRIPTION OF THE PREFERRED EMBODIMENTS

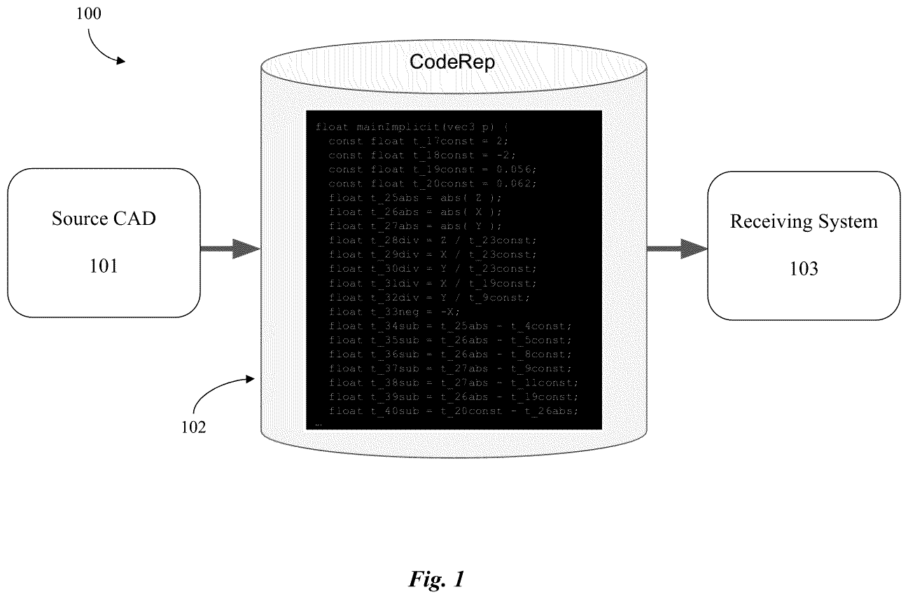

With reference to FIG. 1, an exemplary top-level functional flow diagram for code interoperability 100 is shown. As shown, one or more CAD bodies can be exchanged between a first/source CAD program 101 and a target receiving system 103. As one example, the target can be a second CAD program which is different than the first/source CAD program 101. As another example, the target can be a device/machine, such as a 3D printer or CNC machine. The exchange can include providing the one or more CAD bodies in the form of CodeRep 102. In generating the CodeRep 102, the first/source CAD program 101 can first determine for the one or more CAD bodies one or more corresponding implicit equations/functions. As just one example, such an implicit equation/function can be the signed distance function (SDF) of a mesh of a given one of the CAD body/bodies. Having determined the implicit equation(s)/function(s), the first/source CAD program 101 can express these implicit equation(s)/function(s) as the CodeRep 102.

As an example, the CodeRep 102 can utilize OpenGL Shading Language (GLSL) code. While the generated CodeRep 102 is shown and described as using GLSL, this is for illustration purposes only. Those of ordinary skill in the art will understand that the generated CodeRep 102 can be formatted as desired. In other examples, the generated CodeRep 102 can utilize Python, C, or C# code. Also, other possibilities exist. For example, the implicit equation(s)/function(s) can be expressed declaratively in a structured format, such as via JSON or XML. To facilitate discussion, expression as code (e.g., GLSL) will generally be discussed, with it being understood that expression in a structured format (e.g., JSON) is also possible. In this way, CodeReps can provide benefits including being small, precise, and intelligent.

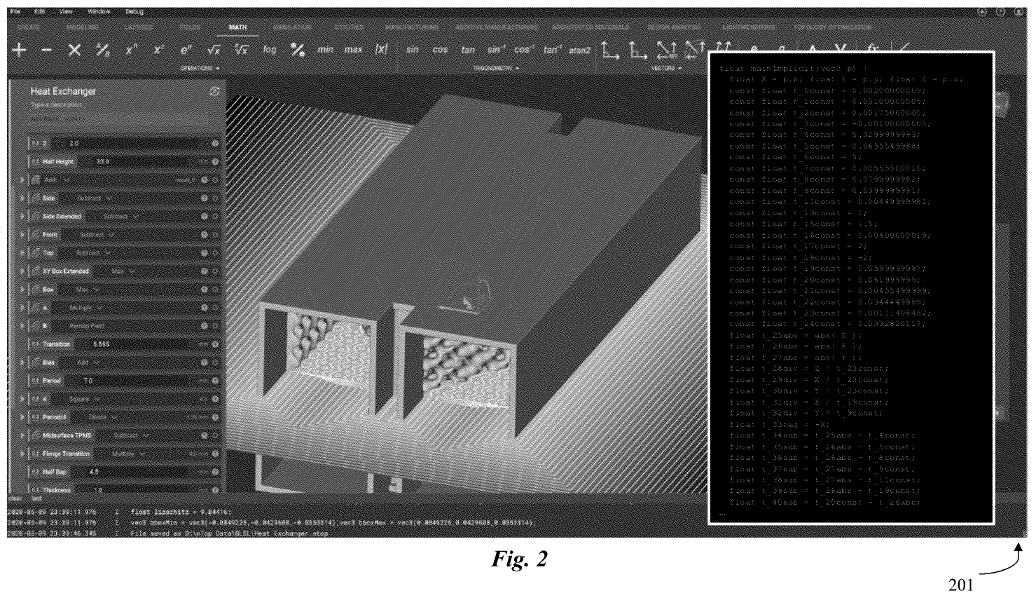

With reference to FIG. 2, in some embodiments, the generated CodeRep 102 can include code 201 that the first/source CAD program 101 would still generate even if the exchange were not to be performed. For example, in these embodiments, the first/source CAD program 101 can generate such code 201 for display purposes, with the code being provided to a graphics processing unit (GPU) to allow the corresponding CAD body/bodies to be displayed. In this way, the exchange approaches discussed herein can advantageously harness this display code for a second purpose (i.e., for exchange).

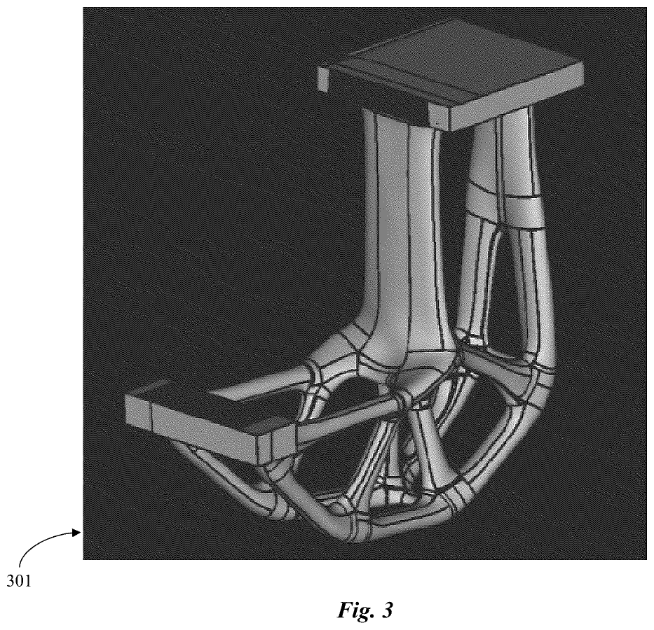

In some embodiments, turning to FIG. 3, the generated CodeRep 102 can be converted to explicit form for purposes of saving or exchange. As some examples, such conversion can produce entities 301 such as meshes, slices, sub-division (sub-d) models (a type of parametric surface), boundary representations (B-reps; a type of parametric surface), VDB representations (e.g., representations involving sparse volumetric data, voxels, and/or finite element (FE) meshes). However, this conversion yields only an approximation of the corresponding CAD body/bodies. In contrast, by directly exchanging the generated CodeRep, the loss of fidelity does not occur.

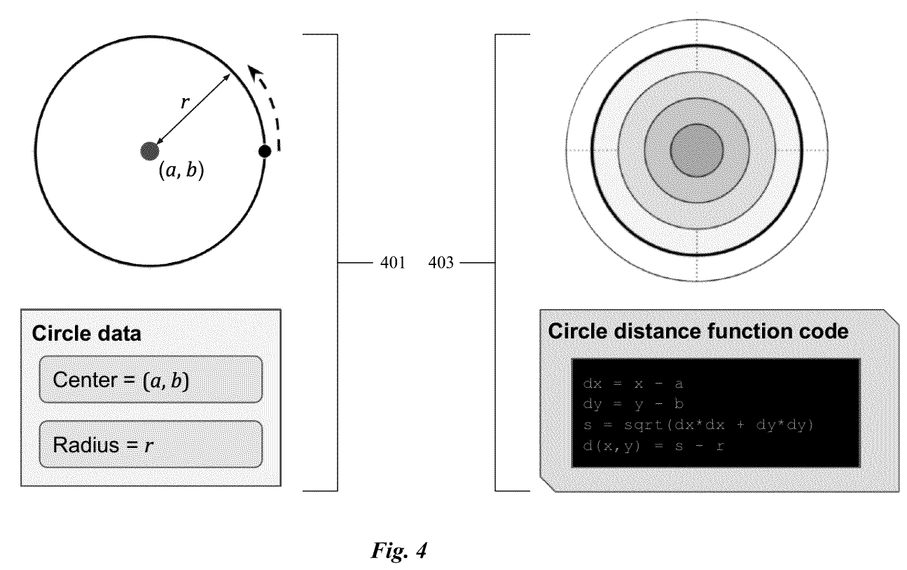

With reference to FIG. 4, implicits can describe shapes in terms of equations/functions. In contrast, explicits can directly describe those same shapes. For example, a circle can be described in an explicit and direct fashion 401, in terms of a center at coordinates a, b, and a radius r. In contrast, the same circle can be described in an implicit fashion 403, such as through one or more equations which can be expressed as the code of 403. Describing shapes in an implicit fashion advantageously yields functions/equations which can take varying inputs (e.g., spatially varying inputs). In this way, replayability and parametric editing of an exchanged CAD body can be achieved. For example, where the target receiving system 103 is a 3D printer, the printer can alter parameter values for the CAD body so as to: a) modulate energy settings based on pyrometer imaging; b) control wall thickness and registration based on camera feedback; and c) produce, using real-time inspection data, a digital twin that directly models a fabricated result.

Because of performing CAD body exchange via the CodeRepl02, the 3-D printer does not need to run the CAD software which provided the CAD body/bodies. Where the target receiving system 103 is a second CAD program, the second CAD program can, as just an example, allow for (e.g., via a UI) alteration of parameter values for the CAD body/bodies such that different thicknesses and diameters can be specified for the CAD body. More generally, by receiving the CodeRep 102, the second CAD program receives the CAD body/bodies with full design intent intact, and with full parametric edits being allowed. In this way, a solution is provided for the parametric, associative interoperability problem which plagues CAD/CAM/CAE.

Also, the target receiving system 103 can, using the received CodeRep, perform various visualization with respect to the CAD body/bodies which correspond to the CodeRep. For example, the target receiving system 103 can use the received CodeRep to allow for lightweight visualization of a mockup of the CAD body/bodies, such as in support of product lifecycle management (PLM) operations. As just some examples, such lightweight viewing can be implemented via one or more ray casting, implicit structure generation, and meshes (e.g., cached meshes). Further still, the target receiving system 103 can use the received CodeRep to display graphical previews of the CAD body/bodies, using WebGL or another rendering approach. In some embodiments, the previews can be generated from features/constituents which make up the CAD body/bodies.

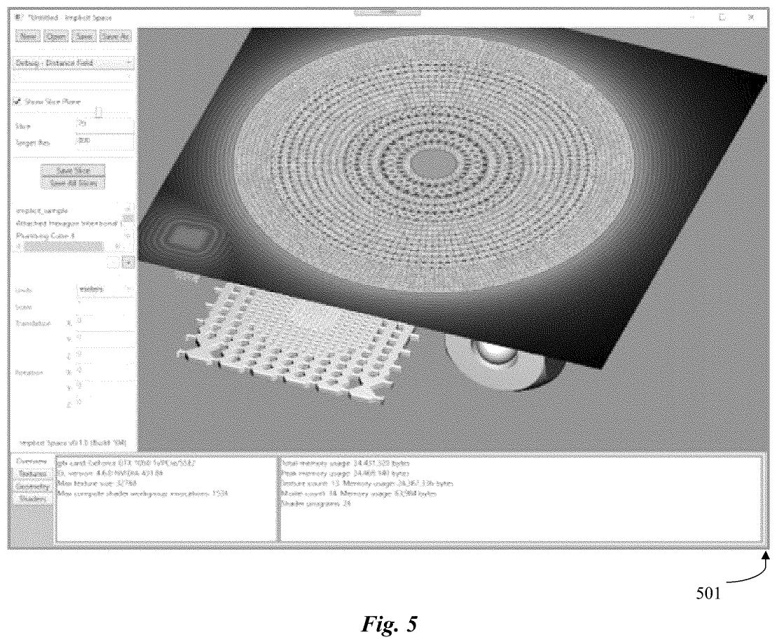

Because code (or a structured format such as XML) is the exchange medium for the CAD body/bodies, easy consumption/use at the target receiving system 103 is achieved (e.g., as opposed to using an unwieldly and/or poorly structured data format as the exchange medium). With reference to FIG. 5, a target receiving system 103 capable of using VDB input can, for example after minor modifications and/or add-ons, be capable of reading a CodeRep (e.g., a CodeRep for an exchanged CAD body 501). Likewise, a target receiving system 103 capable of computing a signed distance field (SDF) from a mesh, lattice, B-rep, or other source can, for example after minor modifications and/or add-ons, be capable of reading a CodeRep. Further likewise, a target receiving system 103 capable of producing support structures (e.g., 3D-printing support structures) from implicits can, for example after minor modifications and/or add-ons, be capable of reading a CodeRep. As such, slicing software (e.g., for purposes of supporting 3D printing), CAD software, and other targets can use a CodeRep as input.

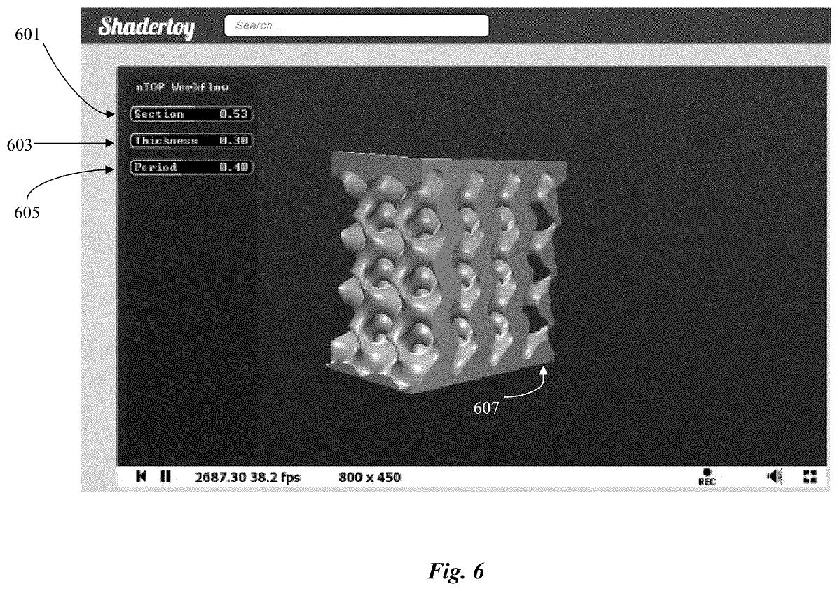

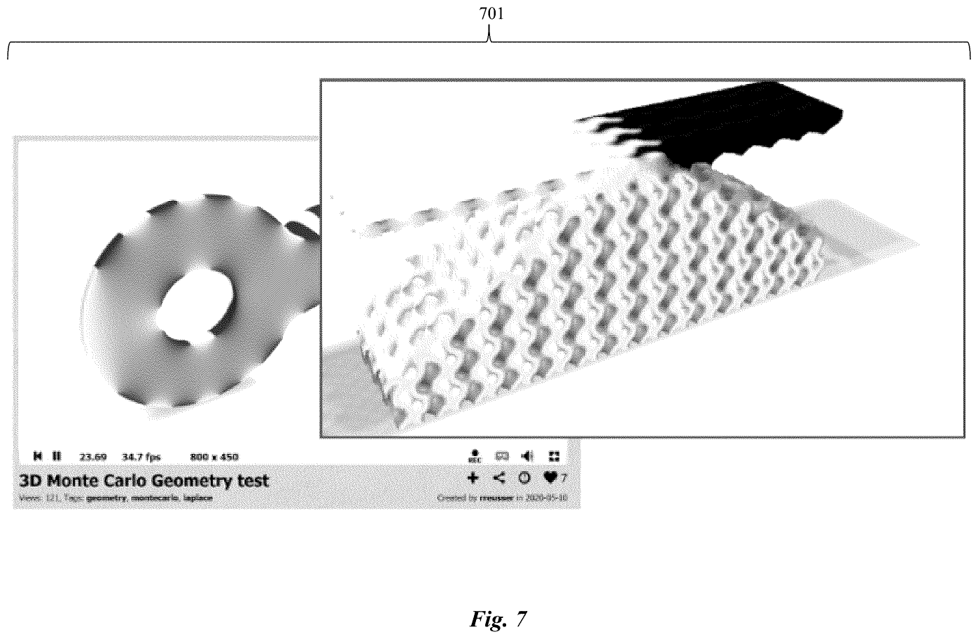

Turning to FIG. 6, an example target UI which leverages the ability of the exchanged CodeRep to take varying inputs is shown. In particular, the example UI allows a user to specify a section value 601, a thickness value 603, and a period value 605 for a displayed CAD body 607. By using the user-specified values as the inputs to the CodeRep, the target can display to the user an updated version of the CAD body, reflecting the specified section/thickness/period values. More generally, the input parameters acceptable by the CodeRep can be exposed to the user by the target. In this way, the target can provide capabilities including but not limited to parametric edits, configuration changes, and real-time process correction (e.g., where the target is a 3D printer or CNC machine). Accordingly, as depicted in FIG. 7, the target can allow the user to implement CAD body/bodies changes 701 quickly (e.g., via a copy/paste operation), such as to adapt a product to fit new research results.

In generating the CodeRep, the operations performed by the first/source CAD program can depend upon the particular features/constituents that correspond to the CAD body/bodies to be exchanged. In various embodiments, the handling of a given feature/constituent can depend upon whether the feature/constituent is a native feature/constituent or an external function feature/constituent. In some examples, native features/constituents can include features/constituents that involve math, basic shapes, and vector fields. Then, external function features/constituents can include features/constituents which involve external geometry such as meshes, lattices, finite element (FE) results, graph lattices, and VDB data.

The CodeRep can be internally represented as an abstract syntax tree of the implicit expression, with the native features/constituents as pure code and the external function features/constituents as calls to the corresponding external functions. The target can be expected to provide the called external functions. The tree can be used to generate optimized code that runs on a CPU, on a GPU, and/or in cooperation with various frameworks, as needed. As such, the source/first CAD program can generate the CodeRep via the abstract syntax tree.

In various embodiments, rather than including calls to external functions in the tree, corresponding traditional geometry representations can be stored (e.g., traditional geometry representations corresponding to various meshes, various lattices, and various FE results). Here, the target can be expected to provide the external functions for the SDFs of such traditional geometry representations. Also, in various embodiments, proprietary, specialized, and/or trade secret geometries and/or construction techniques can be obfuscated in external functions, such as via sparse field structures like VDBs. Also, a kernel of the first/source CAD program that includes the needed external functions can be provided to the target, thereby allowing for benefits such as complete parametric editing at the target.

In some embodiments, for all external function features/constituents, a backup texture can be provided when exchanging CodeReps. Such a backup texture can include an internal display cache of the first/source CAD program, a VDB-format texture, or an implicit representation compressed using machine learning, as just some examples.

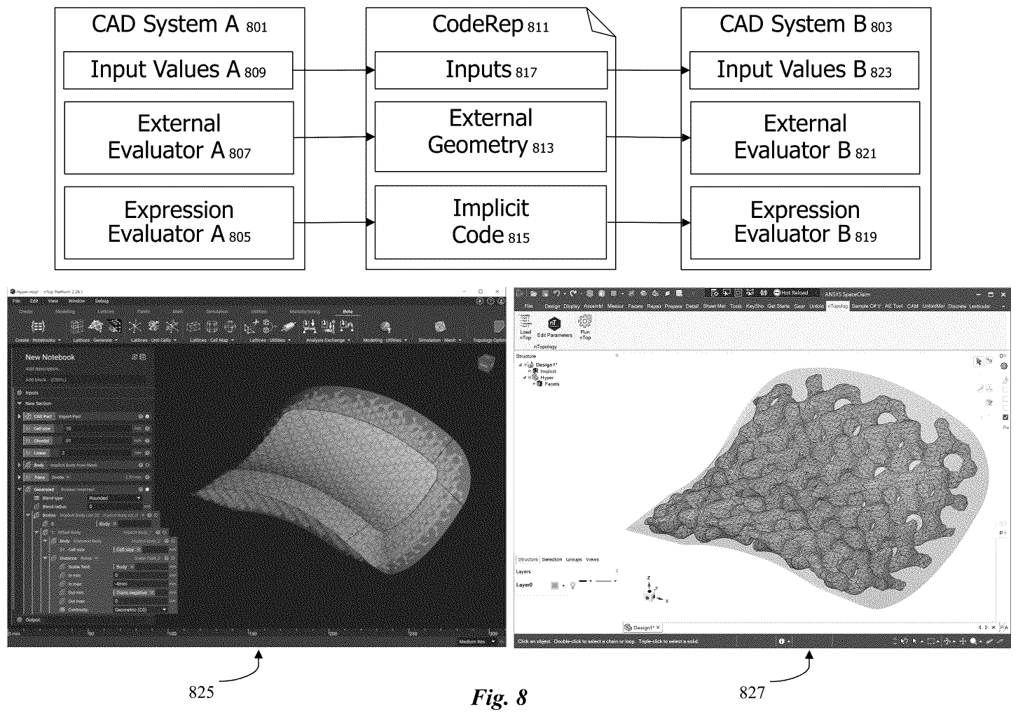

Shown in FIG. 8 is an example of both varying inputs/parameters and referencing external geometry. In particular, the first/source CAD program (e.g., “CAD System A” 801) provides the depicted CAD body to the target (e.g., “CAD System B” 803). The features/constituents of the CAD body include both native features/constituents and external function features/constituents. For CAD System A 801, use of the native features/constituents is supported by “Expression Evaluator A” 805. Then, use of the external function features/constituents is supported by “External Evaluator A” 807. For CAD System A 801, “Input Values A” 809 represent exemplary values of inputs/parameters for the CAD body. As noted, a CodeRep can be represented as an abstract syntax tree.

The abstract syntax tree for the CAD body being exchanged is shown in FIG. 8 via “CodeRep” 811. The “External Geometry” 813 of the abstract syntax tree corresponds to the discussed calls to external functions (i.e., the calls to external functions for the external function features/constituents of the CAD body being exchanged). The “Implicit Code” 815 of the abstract syntax tree corresponds to the discussed pure code (i.e., the pure code for the native features/constituents of the CAD body being exchanged). Also, the “Inputs” 817 of the abstract syntax tree correspond to exchange from CAD System A 801 to CAD System B 803 of the particular values for inputs/parameters for the CAD body.

Then, CAD System B 803 includes “Expression Evaluator B” 819. Using Expression Evaluator B 819, CAD System B 803 can use the native features/constituents of the CAD body being exchanged via the CodeRep. Using “External Evaluator B” 821 CAD System B 803 can use the external function features/constituents of the CAD body being exchanged via the CodeRep. “Input Values B” 823 correspond to the exchanged particular values for inputs/parameters of the CAD body for CAD System B 803. These values can be altered at CAD System B, thereby allowing for benefits including parametric editing at CAD System B to accrue. According to the example of FIG. 8, CAD System B 803 has altered the inputs/parameters so as to cause the CAD body as originally exchanged (see screenshot 825) to be as depicted by screenshot 827.

As systems that permit the sharing of executable code can introduce the potential for malicious behavior, the CodeRep (and/or the execution environment which runs the CodeRep) can be implemented so as to prevent such behavior, and to be secured from vulnerabilities. For example, one potential vulnerability regards out-of-bounds memory addressing. To combat this potential vulnerability, the CodeRep can be implemented such that all logic is first order (e.g., first order in the GLSL sense). Another potential vulnerability can be an increased risk of blowing/overflowing the stack instead of just the heap. To combat this potential vulnerability, the CodeRep (and/or the execution environment which runs the CodeRep) can be implemented such that behavior and memory requirements are known at compile time. In yet another example, a potential vulnerability can include the CodeRep gaining OS-level capabilities. To combat this potential vulnerability, the CodeRep can stipulate that it run on the target in a sandboxed execution environment that disallows OS access (or the target can, in another fashion, be set to sandbox the code). In some embodiments, the abstract syntax tree and execution environment can implement advanced assembler/compiler features such as performing loop optimization (e.g., via goal-seeking and/or constraint management functionality).

Also, in various embodiments the first/source CAD program and/or the target can be implemented to read a CodeRep in the fashion of a new function in its own implicit model. For example, such capability can allow the first/source CAD program and/or the target to utilize parametric variation available in the CodeRep.

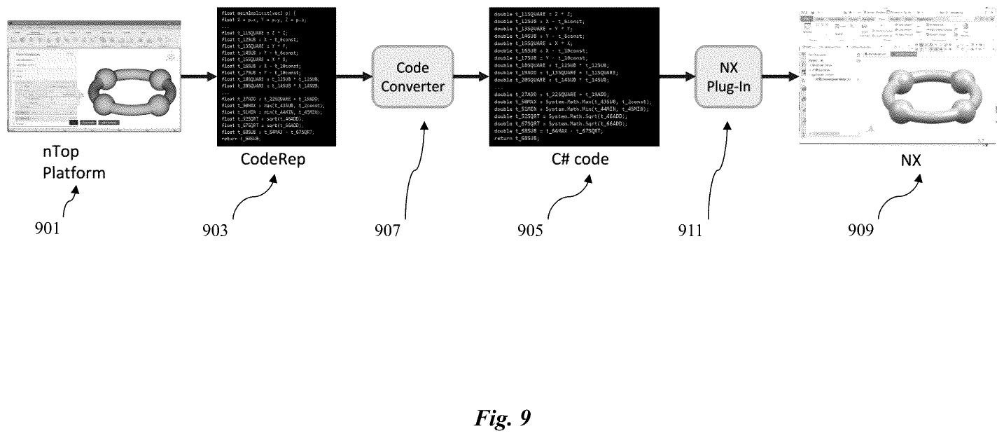

As another example, CAD body/bodies exchange can be performed in the manner depicted in FIG. 9. Here, the first/source CAD program 101 (e.g., the “nTop Platform” 901) can generate the CodeRep 102 (e.g., the “CodeRep” 903) for the CAD body/bodies. The generated CodeRep 102 can be of a first code type (e.g., GLSL code). Subsequently, the first/source CAD program can convert the CodeRep to a second code type (e.g., to C# code 905, as depicted by FIG. 9). Functionality utilized by the first/source CAD program to perform the conversion is labeled “Code Converter” 907 in FIG. 9. The second/target CAD program, labeled as “NX” 909 in FIG. 9, can utilize a plug-in (labeled “NX Plug-In” 911 in FIG. 9) to receive the second-type code (e.g., C# code) and utilize it to import the CAD body/bodies. As an example, the plug-in can use the second-type code to create a convergent body/mesh body within the second/target CAD program. Where there is similarity between the first code type and the second code type, streamlined functionality of the code converter can be achieved. As an example, such can be the case where the first code type is GLSL and the second code type is C#. Moreover, having the second code type be C#(or a similar code type) can be advantageous, due to ease of compiling and executing at runtime, using .NET technology. As just an example, the second/target CAD program can be a version of Siemens NX CAD.

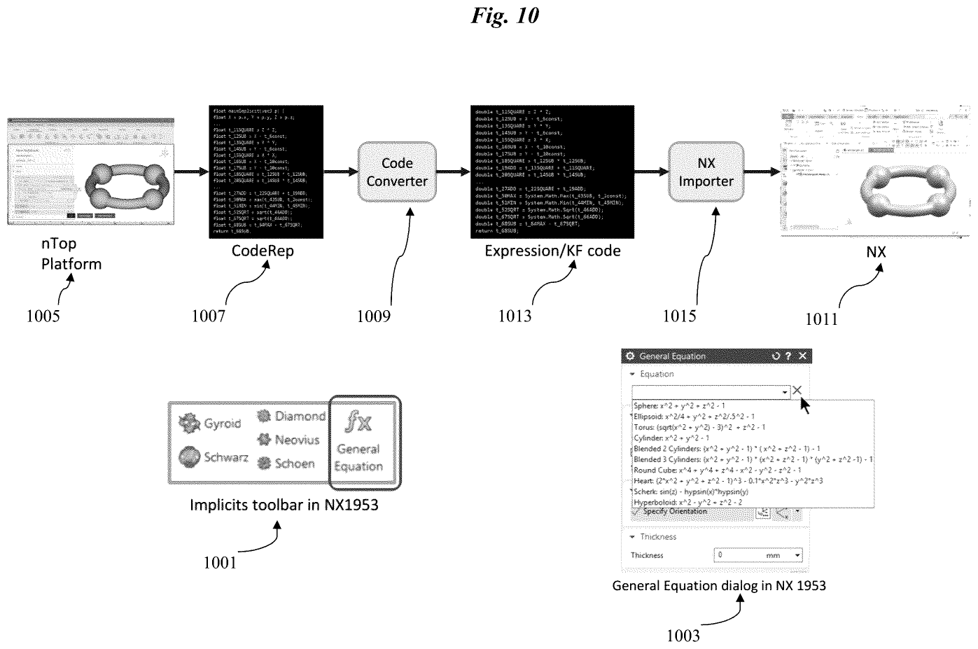

Turning to FIG. 10, certain CAD programs (e.g., Siemens NX CAD versions NX1953 and higher) can be capable of directly consuming code definitions. For example, such CAD programs can allow a user to define a general implicit body via user-supplied code (e.g., as per the implicits toolbar 1001 and general equation dialog 1003). As an illustration, the user-supplied code can include single-line NX expressions, in the case of Siemens NX CAD versions NX1953 and higher. Moreover, for certain such CAD programs, the code (e.g., NX expressions) can reference other code (e.g., other NX expressions). Also, for certain such CAD programs the code (e.g., NX expressions) can call functions (e.g., functions written in the Siemens Knowledge Fusion (KF) language). As a further example, where the second/target CAD program is capable of directly consuming code definitions, CAD body/bodies exchange can be performed without call for a plug-in of the sort discussed in connection with FIG. 9. Such a circumstance is depicted in FIG. 10. As depicted in FIG. 10, the first/source CAD program (labeled “nTop Platform” 1005) can, as in FIG. 9, generate a CodeRep (labeled “CodeRep” 1007) for the CAD body/bodies.

Also, the generated CodeRep 1007 can be of a first code type (e.g., GLSL code), and the first/source CAD program 1005 can convert (see “Code Converter” 1009) the generated CodeRep to a second code type. For the example of FIG. 10, the second code type can be a code type which the second/target CAD program (labeled “NX” 1011) can directly consume, as discussed. Such second code type is Siemens Expression/KP code 1013 according to the example of FIG. 10. Importer functionality of the second/target CAD program (labeled “NX Importer” 1015) can receive the second-type code. Subsequently, the second/target CAD program 1011 can utilize the second-type code to import the CAD body/bodies. Where, for example the second/target CAD program 1011 is Siemens NX CAD version NX1953 or higher, an NX/Open program can act to convert the first-type code (e.g., GLSL code) to Expression/KP syntax, and import it into the second/target CAD program as an NX general equation feature. As another example where the second/target CAD program is Siemens NX CAD version NX1953 or higher, the NX custom feature facility can be used. In this way, implicit-to-mesh code of the first/source CAD program can be used instead of implicit-to-mesh code of the second/target CAD program. As such, a higher quality mesh can be generated. For both these examples, analogous operations can be performed where the second/target CAD program is other than the noted Siemens NX CAD version, but offers similar functionality.

In further detail, the NX general equation feature approach can involve first-type code (e.g., GLSL code) being converted to Expression/KP form, and being stored in the NX general equation feature. Such conversion can make use of functions such as +,−, *,/, trig functions, sqrt, min, and max offered by the Expression subsystem. Subsequently, the second/target program can perform conversion to a convergent body. The equation code can be organized in several ways. As one example, the equation code can be in the form of one large single-line expression. As another example, the equation code can be in the form of an expression that references other expressions (e.g., with there being one expression for each line of the GLSL or other first-type code). As yet another example, the equation code can be in the form of an expression that calls a KF function (e.g., a KF function which resides in a separate file).

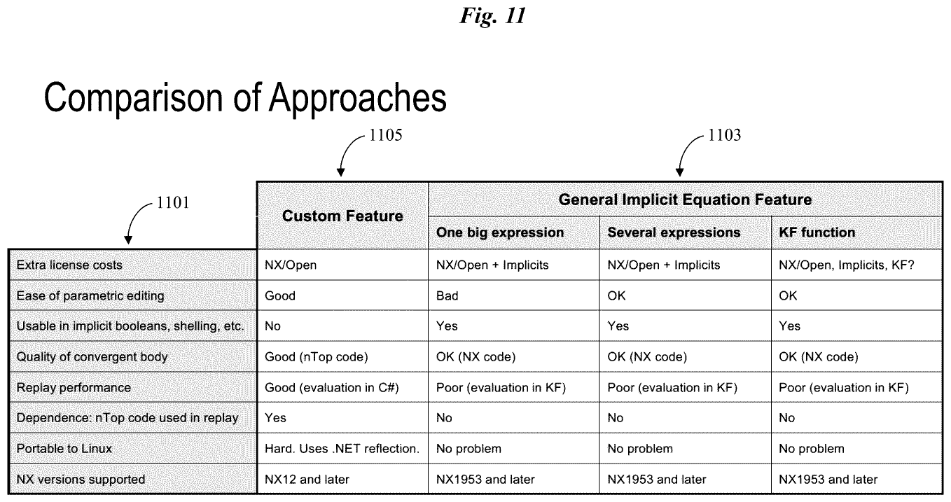

The custom feature approach can, in further detail, involve code of the first type being stored as a feature (e.g., in text format). As an alternative, the first-type code (e.g., GLSL code) can be converted to a different code type (e.g., to C# code) prior to storage in the feature. Then, at replay time, the implicit function code can be executed (e.g., using .NET reflection). According to the custom feature approach, implicit-to-mesh code of the first/source CAD program can be used, with such implicit-to-mesh code calling the implicit function code. The resultant feature output can be a convergent body/mesh. Further, a UI dialog, which allows for altering of various parameters of the imported CAD body/bodies, can be provided to a user. FIG. 11 is a table comparing various aspects 1101 of the NX general equation feature (referred to as “General Implicit Equation Feature” 1103 in the figure) and custom feature approaches 1105.

The use of CodeReps can yield various benefits. As one example benefit, CodeReps are simple, easy to understand, and unambiguous. In particular, as just some examples, for CodeReps: a) the basis is simple math, rather than some other overly-complex basis; b) the code is unambiguous (e.g., unlike feature definitions); c) the inputs thereof are conveniently three numbers: X, Y, and Z and additional parameters to enable variation; d) the output thereof is returned as a number (e.g., a float or double); e) assignment statements are available; f) right-hand sides are simple math expressions; f) arithmetic operations including +,−, *, and/are available; and g) basic math functions including trig functions (e.g., sin and cos), abs, sqrt, min, and max are available.

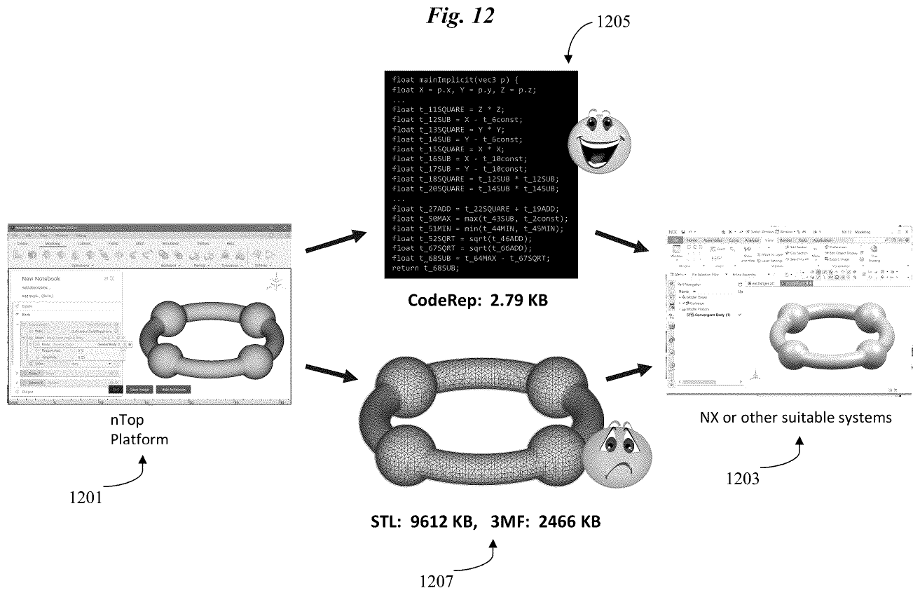

With reference to FIG. 12, another example benefit of the use of CodeReps is small size. For example, as depicted by FIG. 12, where a first/source CAD program (e.g., the “nTop Platform” 1201) is to export a CAD body/bodies to a second/target CAD program (e.g., “NX or other suitable systems” 1203), a corresponding CodeRep file 1205 can be smaller than a typical mesh file 1207 by a factor of 1000 or more. In this way, CodeReps can be light and efficient, compared to, for instance, meshes and slices which are slow and large.

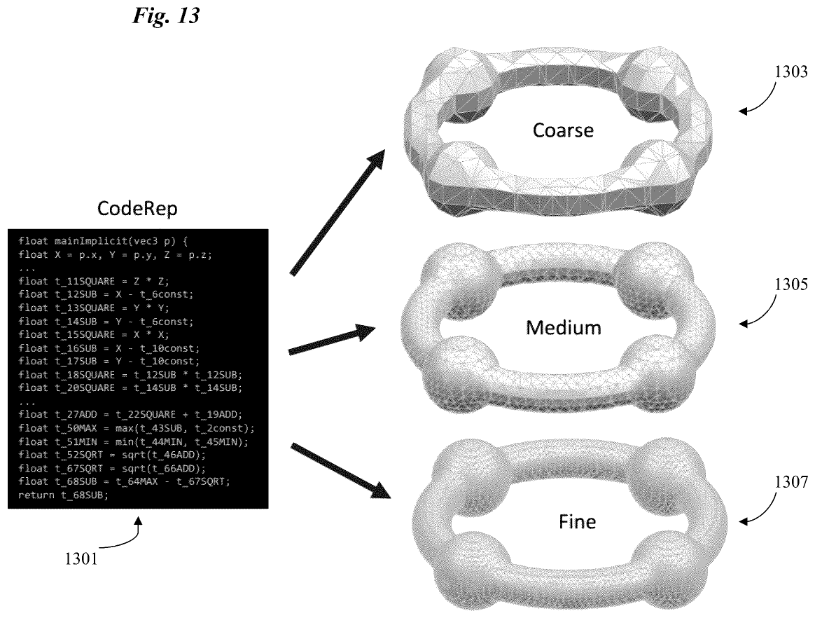

With reference to FIG. 13, a further example benefit of the use of CodeReps is that CodeReps are precise. More specifically, as just some examples a CodeRep: a) is a precise representation of the original shape in the first/source CAD program; b) is not an approximation like meshes and voxels; c) can be used by the target to generate whatever representations it needs, with as much accuracy as is desired; and d) can generate different meshes for different purposes, and accurate slices for additive manufacturing/3D printing. In this way, for instance, one or more CAD bodies can be sent downstream in a precise format, for example to be evaluated by a 3D printer or 3D printer prep software, on the fly. For instance, as shown by FIG. 13, a CodeRep 1301 can be used to generate different mesh models including a coarse mesh model 1303, a medium mesh model 1305, and a fine mesh model 1307.

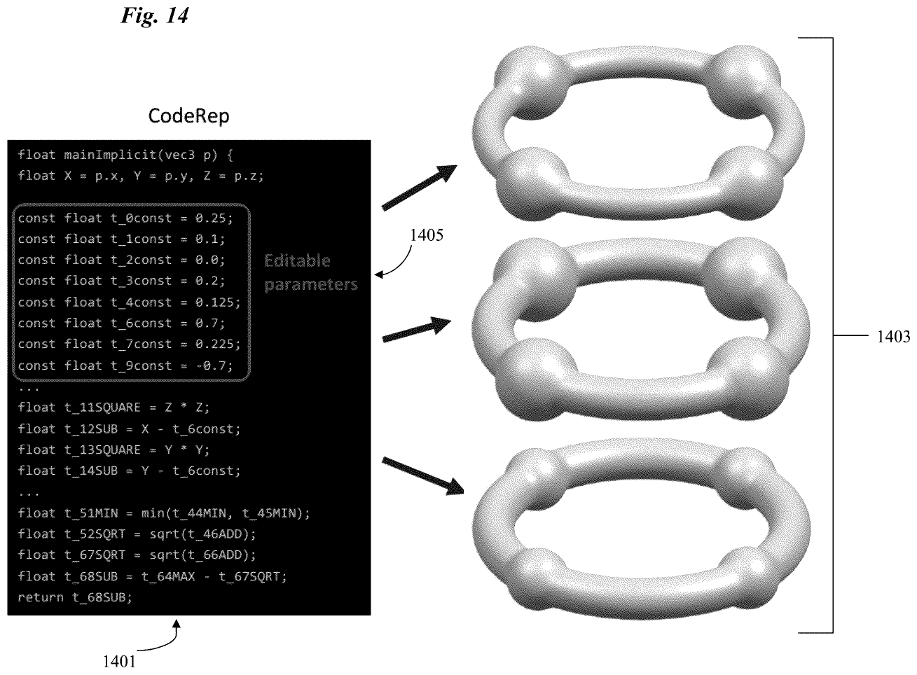

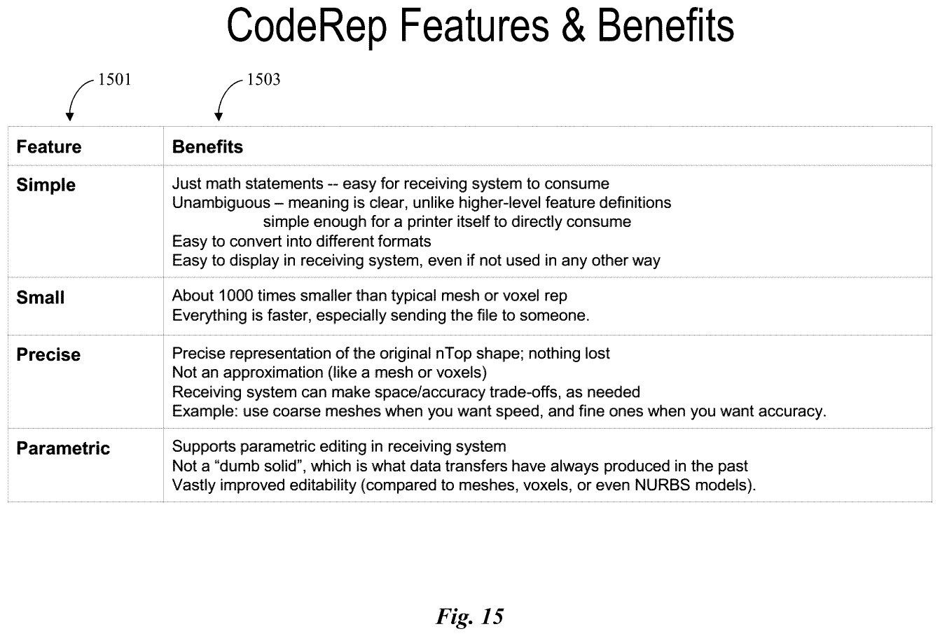

With reference to FIG. 14, yet another example benefit of the use of CodeReps is allowing for parametric editing at the target (e.g., a target CAD system). For instance, a CodeRep can be replayed at the target, thereby allowing for parametric editing. According to the example of FIG. 14, the use of CodeRep 1401 provides for model editing 1403 by replaying the CodeRep 1401 with different parameter values (e.g., via editable parameters 1405). Typical CAD body exchange approaches do not provide for such parametric editing. Editing of parameters of the CodeRep can, for instance, be performed via manual code editing and/or via UI fields. FIG. 15 is a table summarizing some example features 1501 and benefits 1503 of the use of CodeReps for CAD body exchange purposes. As reflected by FIG. 15, the use of CodeReps can provide for parametric editing and real-time process correction at a target manufacturing system. As an illustration, an input expression for a CodeRep can be changed on-the-fly, thereby feeding sensor output back into the corresponding CAD body during manufacturing.

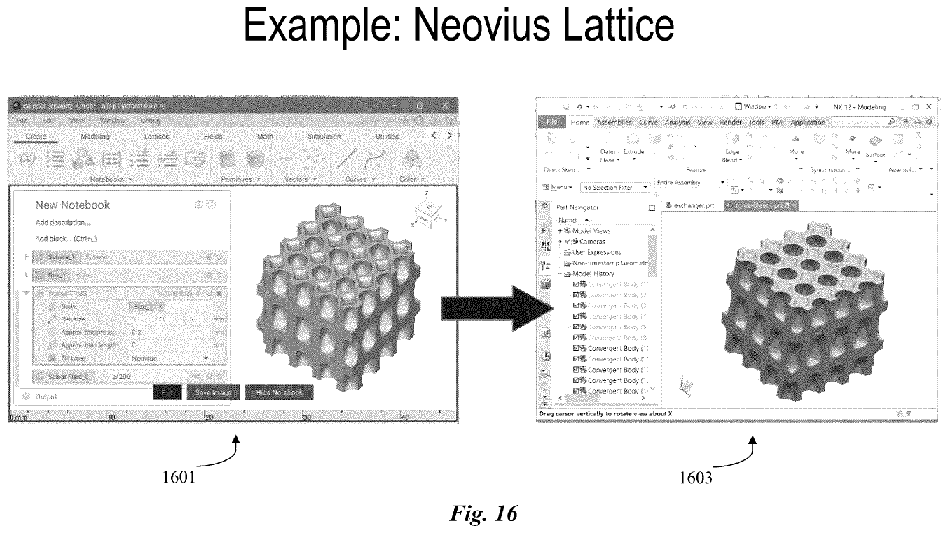

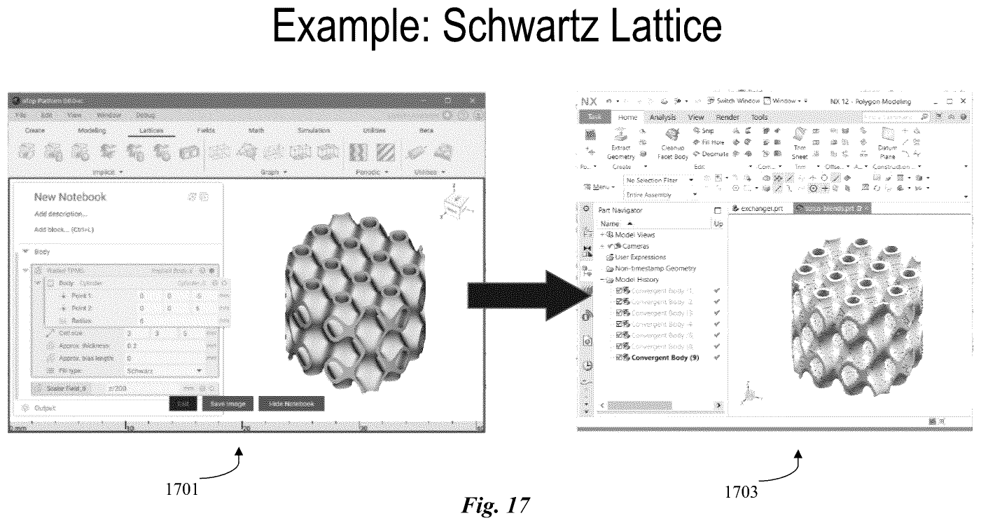

Shown in FIGS. 16 and 17 are two examples of operations which are facilitated via the operations discussed herein. As depicted by FIG. 16, a Neovius lattice can be created by generating it in a first/source CAD program (e.g., the first/source CAD program 101; see screenshot 1601), and providing it, via the exchange approaches discussed herein, to a second/target CAD program (see screenshot 1603). In contrast, for instance, the Neovius lattice may not be available via the implicits module of the second/target CAD program. As such, the Neovius lattice—at best—might only be created in the second/target CAD program by tortuously entering the equation manually.

As depicted by FIG. 17, a rich Schwartz lattice can be created by generating it in a first/source CAD program (e.g., the first/source CAD program 101; see screenshot 1701), and providing it, via the exchange approaches discussed herein, to a second/target CAD program (e.g., Siemens NX CAD; see screenshot 1703). When generating/exchanging the Schwartz lattice as mentioned, the resultant lattice can be richly used at the target, for instance allowing a user to vary cell size and wall thickness. In contrast, using the NX implicits module of Siemens NX CAD, merely a simple version of the lattice can be created. An analogous situation holds for gyroids.

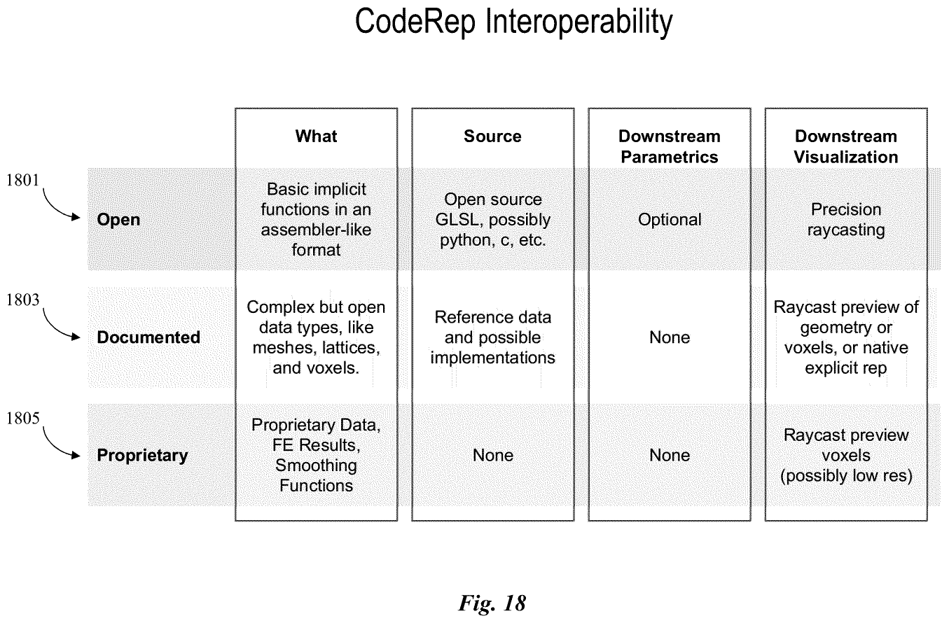

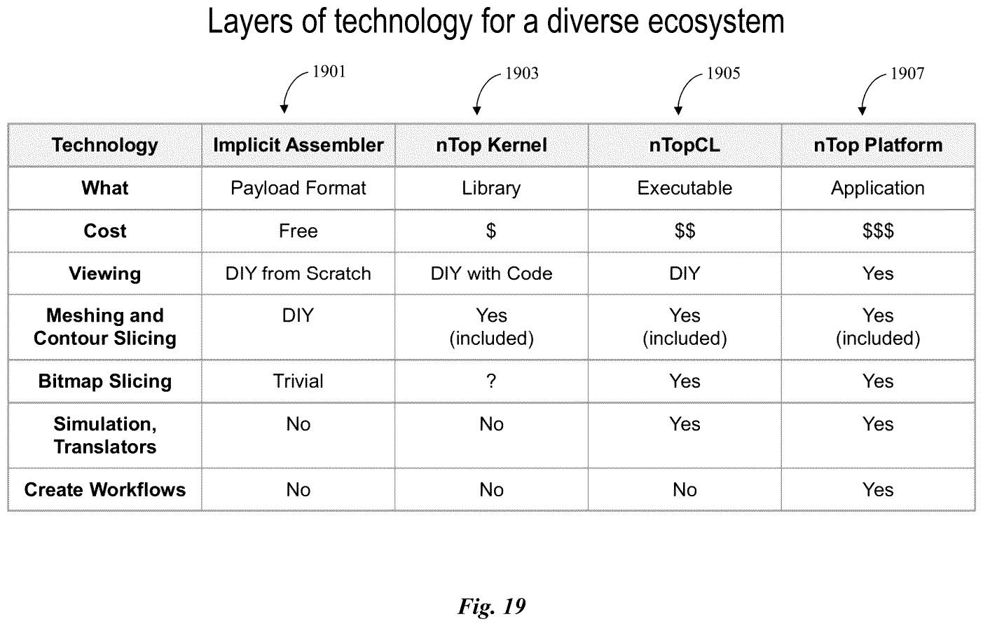

FIG. 18 is a table setting forth exemplary CodeRep interoperability aspects which can be provided in an open fashion 1801, a documented fashion 1803, and a proprietary fashion 1805. FIG. 19 is a table setting forth various ways for implementing an ecosystem based on the technology discussed herein. In particular, the table of FIG. 19 addresses an implicit assembler payload format 1901, an nTop kernel library 1903, an nTopCL executable 1905, and an nTop platform application 1907. Also, in some embodiments, the functionality discussed herein can be standardized and/or made part of an existing standard (e.g., made part of the 3MF and/or STEP standards).

Via the functionality discussed herein, interoperability between a first/source CAD program and a target can be achieved using CodeReps, with one or more CAD bodies being exported from the first/source CAD program and imported by the target. Such a CodeRep can be provided to the target, either from their abstract representation or in a translated form (e.g., translated from an initial GLSL form to another form such as C#, Python, or JSON). Moreover, under certain circumstances the target can alternately or additionally receive a backup texture (e.g., an internal display cache of the first/source CAD program). The use of CodeReps can extend the exchange of meshes, lattices, and various geometric structures that can be efficiently converted to implicit modes, as just some examples. Using a received CodeRep, the target can perform various operations, such as: a) providing a voxel or other preview of one or more exchanged CAD bodies; and b) allowing for replay and parametric edits of one or more exchanged CAD bodies.

### Hardware and Software:

According to various embodiments, various functionality discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

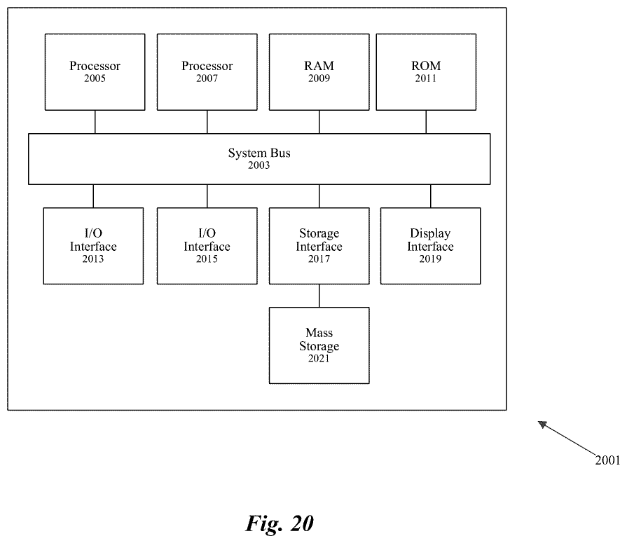

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 20 is an example computer employable in various embodiments of the present invention. Exemplary computer 2001 includes system bus 2003 which operatively connects two processors 2005 and 2007, random access memory (RAM) 2009, read-only memory (ROM) 2011, input output (I/O) interfaces 2013 and 2015, storage interface 2017, and display interface 2019. Storage interface 2017 in turn connects to mass storage 2021. Each of I/O interfaces 2013 and 2015 can, as just some examples, be a Universal Serial Bus (USB), a Thunderbolt, an Ethernet, a Bluetooth, a Long Term Evolution (LTE), a 5G, an IEEE 488, and/or other interface. Mass storage 2021 can be a flash drive, a hard drive, an optical drive, or a memory chip, as just some possibilities.

Processors 2005 and 2007 can each be, as just some examples, a commonly known processor such as an ARM-based or x86-based processor. Computer 2001 can, in various embodiments, include or be connected to a touch screen, a mouse, and/or a keyboard. Computer 2001 can additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules can, for example, be programmed using Python, Java, JavaScript, Swift, C, C++, C#, and/or another language. Corresponding program code can be placed on media such as, for example, DVD, CD-ROM, memory card, and/or floppy disk. It is noted that any indicated division of operations among particular software modules is for purposes of illustration, and that alternate divisions of operation may be employed. Accordingly, any operations indicated as being performed by one software module can instead be performed by a plurality of software modules. Similarly, any operations indicated as being performed by a plurality of modules can instead be performed by a single module. It is noted that operations indicated as being performed by a particular computer can instead be performed by a plurality of computers. It is further noted that, in various embodiments, peer-to-peer and/or grid computing techniques may be employed. It is additionally noted that, in various embodiments, remote communication among software modules may occur. Such remote communication can, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

1. A computer-implemented method for computer aided design (CAD) exchange comprising:
determining, by a source computing system, one or more implicit equations/functions for a CAD body;
expressing, by the source computing system, the implicit equations/functions as code;
exchanging the code between the source computing system and a target system; and
displaying, based on the code, the CAD body at the target system,
wherein a portion of the code provided to the target system is also provided to a graphics processing unit of the source computing system to allow the CAD body to be displayed by the source computing system.

2. The computer-implemented method for CAD exchange of claim 1, wherein the CAD body comprises one or more external function features/constituents, and wherein the code comprises one or more calls to corresponding external functions.

3. The computer-implemented method for CAD exchange of claim 1, further comprising providing, by the source computing system to the target system, a backup texture for the CAD body.

4. The computer-implemented method for CAD exchange of claim 1, wherein the portion of the code provided to the graphics processing unit of the source computing system would be generated for display purposes, even without exchanging the code between the source computing system and the target system.

5. The computer-implemented method for CAD exchange of claim 1, wherein the determination of the one or more implicit equations/functions includes determination of at least one signed distance function (SDF).

6. The computer-implemented method for CAD exchange of claim 1, wherein the code accepts varying inputs, and wherein the varying inputs allow for one or more of parametric edits and manufacturing process correction at the target system.

7. The computer-implemented method for CAD exchange of claim 1, wherein the portion of the code provided to the graphics processing unit of the source computing system is OpenGL Shading Language (GLSL) code.

8. A system for computer aided design (CAD) exchange comprising:
a source computing system including at least one source computing system processor;
a target computing system including at least one target computing system processor;
a source computing system memory storing instructions that, when executed by the at least one source computing system processor, cause the source computing system to perform:
determining one or more implicit equations/functions for a CAD body,
expressing the one or more implicit equations/functions as code,
providing the code to the target computing system,
providing a portion of the code to a graphics processing unit of the source computing system to allow the CAD body to be displayed by the source computing system, and
displaying the CAD body on the source computing system; and
a target computing system memory storing instructions that, when executed by the at least one target computing system processor, cause the target computing system to display, based on the code, the one or more CAD bodies at the target computing system.

9. The system for CAD exchange of claim 8, wherein the CAD body comprises one or more external function features/constituents, and wherein the code comprises one or more calls to external functions.

10. The system for CAD exchange of claim 8, wherein the instructions, when executed by the at least one source computing system processor, further cause the source computing system to provide, to the target computing system, a backup texture for the CAD body.

11. The system for CAD exchange of claim 8, wherein the portion of the code provided to the graphics processing unit of the source computing system would be generated even without providing the code to the target computing system.

12. The system for CAD exchange of claim 8, wherein the determination of the one or more implicit equations/functions comprises determination of at least one signed distance function (SDF).

13. The system for CAD exchange of claim 8, wherein the code accepts varying inputs, and wherein said varying inputs allow for one or more of parametric edits and manufacturing process correction at the target computing system.

14. The system for CAD exchange of claim 8, wherein the portion of the code provided to the graphics processing unit of the source computing system is OpenGL Shading Language (GLSL) code.

15. A non-transitory computer-readable storage medium for computer aided design (CAD) exchange including instructions that, when executed by at least one processor of a source computing system, cause the source computing system to perform a method comprising:
determining one or more implicit equations/functions for a CAD body;
expressing the one or more implicit equations/functions as code;
providing the code to a target system;
providing a portion of the code to a graphics processing unit of the source computing system to allow the CAD body to be displayed by the source computing system; and
displaying the CAD body with the source computing system.

16. The non-transitory computer-readable storage medium for CAD exchange of claim 15, wherein the CAD body comprises one or more external function features/constituents, and wherein the code comprises one or more corresponding calls to external functions.

17. The non-transitory computer-readable storage medium for CAD exchange of claim 15, wherein the instructions, when executed by the at least one processor of the source computing system, further cause the source computing system to provide, to the target system, a backup texture for the CAD body.

18. The non-transitory computer-readable storage medium for CAD exchange of claim 15, wherein the portion of the code provided to the graphics processing unit of the source computing system would be generated even without providing the code to the target system.

19. The non-transitory computer-readable storage medium for CAD exchange of claim 15, wherein the determination of the one or more implicit equations/functions includes determination of at least one signed distance function (SDF).

20. The non-transitory computer-readable storage medium for CAD exchange of claim 15, wherein the code accepts varying inputs, and wherein said varying inputs allow for one or more of parametric edits and manufacturing process correction at the target system.
